(19) United States
(12) Patent Application Publication
(10) Pub. No.: US 2026/0243457 A1
(43) Pub. Date: Aug. 20, 2026

(54) METHOD FOR PROVIDING COOLED AIR

(71) Applicant: KERS INNOVATION UK LIMITEED, Oldham, Greater Manchester (GB)

(72) Inventors: Dean GUEST, Oldham, Greater Manchester (GB); Jonathan CLOUGH, Oldham, Greater Manchester (GB); Neil GUEST, Oldham, Greater Manchester (GB)

(21) Appl. No.: 19/153,897

(22) PCT Filed: Feb. 5, 2024
(86) PCT No.: PCT/GB2024/050307

§ 371 Date: Aug. 5, 2025

(30) Foreign Application Priority Data
Feb. 6, 2023 (GB) 2301647.0

(51) Int. Cl. F24F 11/875; F24F 5/00; F24F 140/20

(52) U.S. Cl. CPC F24F 11/875; F24F 5/0003; F24F 2140/20; F24F 2203/021

(57) ABSTRACT

A method for providing cooled air, using a heat pump configured to provide heated water, is provided. The method comprises: modifying a target temperature of water in a water tank from a first, default, target temperature T₁ to a second target temperature, T₂, where T1<T₂; receiving air at a first air temperature T₃; extracting heat energy from the air, using a heat pump, the extracted heat energy being stored as heat energy in water in the water tank; and providing cooled air, the cooled air being at a second air temperature T₄, where T₄<T₃. A system for providing cooled air, and an apparatus for providing cooled air, is also provided.

### TECHNICAL FIELD

The present disclosure relates to a method for providing cooled air, using a heat pump configured to provide heated water. In particular, the disclosure relates to a method in which a target temperature of water in a water tank is modified from a first, default, target temperature T₁ to a second target temperature, T₂, where T₁<T₂. A system for providing cooled air, and an apparatus for providing cooled air, is also provided.

### BACKGROUND

To reduce reliance on fossil fuels, heating systems for heating homes and water which rely on oil or natural gas are increasingly being replaced by heat pump based systems. Heat pump based systems conventionally heat a heating target fluid using vapor-compression refrigeration cycles.

In air source heat pumps, heat is extracted from air from outside a building, and transferred, via a refrigerant in a vapor-compression refrigeration cycle, into water, which is in turn used either as a hot water source or to heat buildings via radiators or underfloor heating.

At the same time, the rise in global temperatures, and increase in heat waves, has increased the demand for air conditioning systems. Conventional air conditioning systems use a refrigerant circuit containing a refrigerant and including an evaporator, a compressor, and a condenser, similar to a heat pump. The need for cooling is exacerbated in modern buildings, which are well-insulated and thus retain heat, sometimes so well that a separate cooling system becomes necessary.

However, provision of two separate systems (a dedicated air source heat pump and a dedicated air conditioning system), is wasteful. In addition, conventional air conditioning systems are often not very energy efficient.

The inventors have thus appreciated the need for an improved, efficient method for providing cooled air. In particular, the inventors have appreciated the need for such a method which uses a heat pump configured to provide heated water.

### SUMMARY OF THE DISCLOSURE

The present disclosure provides a method, a system, and an apparatus, for providing cooled air, as defined in the appended independent claims, to which reference should now be made. Preferred or advantageous features of the disclosure are set out in the dependent sub-claims.

According to a first aspect of the present disclosure, there is provided a method for providing cooled air, using a heat pump configured to provide heated water. The method comprises: modifying a target temperature of water in a water tank from a first, default, target temperature T₁ to a second target temperature, T₂, where T₁<T₂; receiving air at a first air temperature T₃; extracting heat energy from the air, using a heat pump, the extracted heat energy being stored as heat energy in water in the water tank; and providing cooled air, the cooled air being at a second air temperature T₄, where T₄<T₃.

Conventional air source heat pumps extract heat from air and transfer it into a target fluid (usually water) via a refrigerant vapour-compression cycle. Thus, while the temperature of the water is increased by adding heat energy, the temperature of the air is reduced by extracting heat energy. The air exhausted from the heat pump is thus cooler than the incoming air going into the heat pump. This cooled air may therefore be used to cool a space into which the air is exhausted.

By increasing, on demand, a target temperature of water in the water tank, the present method increases an effective capacity of the heat sink (i.e., the water tank) to store heat energy, thus allowing for more “exhaust” cooled air to be produced by the heat pump than would otherwise be possible.

Advantageously, this method allows for a prolonged cooling effect to be achieved using “waste” or “exhaust” cooled air, while storing the extracted heat energy in the water in the water tank, to provide heated water.

The heat pump may be referred to as an air source heat pump.

It is noted that the target temperature may be modified only temporarily.

In other words, a heating system comprising a heat pump configured to provide heated water may be set to operate to continuously heat water to a default target temperature. Upon initiation of the method, the water in the water tank may be at, or near, the first, default, target temperature. In any event, temporarily modifying the target temperature (temporarily) increases the effective capacity of the water tank to store heat energy, thus permitting the heat pump to operate for longer and provide cooled air for a longer time period.

The method may further comprise: receiving a trigger signal, wherein modifying the target temperature of water in the water tank is in response to the trigger signal. Advantageously, this may allow for prolonged cooling to be provided when required, or on demand.

The trigger signal may be generated by at least one of: a user; a sensor, in particular a temperature sensor; and a controller in response to measurements of a sensor, in particular a temperature sensor.

For example, a user may desire to cool their apartment, and may provide a user input (e.g. via a button, or a touch screen, or an application on a mobile device) to initiate the method.

In another example (or in addition to the above example), a temperature sensor may be provided to measure a temperature inside an apartment, or of the air being received, or of the air being provided. There may be a set temperature at which the temperature sensor generates a trigger signal to trigger the method, to provide cooled air to the apartment.

A controller may be connected to the temperature sensor and generate the trigger signal instead of the temperature sensor generating the signal.

The method may further comprise: upon modifying a target temperature of water in a water tank, changing from receiving the air from an outside air inlet to receiving the air from an inside air inlet, wherein the outside air inlet is without a space to be cooled, and the inside air inlet is within the space to be cooled.

Advantageously, by changing from receiving air from an outside air inlet to an inside air inlet upon the target temperature being modified, when cooling is desired, hot air within the space to be cooled is extracted, thus removing hot air and replacing it with cooled air. The heat pump may already be running before initiation of the method. In other words, the method may further comprise, before the other steps of the method described above, receiving air at a third air temperature T₅ and extracting heat energy from the air, using the heat pump, the extracted heat energy being stored as heat energy in water in the water tank to reach the default target temperature T₁.

It is noted that an air source heat pump may operate to heat water (and provide cooled air) until the water temperature reaches the target temperature, whether that is the default target temperature T₁, or the second target temperature, T₂.

As such, if the water in the water tank is already at the target temperature, the heat pump may not be running at initiation of the method. However, the inlet connection for receiving incoming air may still be changed from an outdoor inlet to an indoor inlet, as set out above.

The method may further comprise: upon modifying a target temperature of water in a water tank, changing from providing the cooled air to an outside air outlet to providing the cooled air to an inside air outlet, wherein the outside air outlet is without a, or the, space to be cooled, and the inside air outlet is within the space to be cooled. Advantageously, by changing from providing cooled air to an outside air outlet to providing cooled air to an inside air outlet upon the target temperature being modified, cooled air may only be provided when desired, rather than being provided at all times when the heat pump is running. In particular when the heated water is used for heating a space, providing the cooled air to the space at the same time may be counterproductive. This step may assist in avoiding this situation.

It is noted that in the method where there is no changing from an outside air outlet to an inside air inlet, the cooled exhaust air may always be provided to an inside air inlet.

The method may further comprise: modifying the target temperature of water in the water tank from the second target temperature, T₂, to the first, default, target temperature T₁. Advantageously, this may allow for (prolonged) cooling to be provided for a limited amount of time, e.g. only as desired.

The target temperature of water in the water tank may be modified to the first, default, target temperature T₁: after a set time period; in response to a signal from a, or the, sensor, in particular a, or the, temperature sensor or a, or the, controller; and/or in response to a user input.

Advantageously, modifying the target temperature to the first, default, target temperature T₁ after a set time period may allow for cooled air to be provided for a predetermined amount of time, e.g. a known amount of time sufficient to cool a space to be cooled, or a known amount of time required for water in the water tank to reach, or near, the second target temperature T₂.

Advantageously, modifying the target temperature to the first, default, target temperature T₁ in response to a signal from a, or the, sensor, in particular a, or the, temperature sensor or a, or the, controller allows for improved temperature control in a space to be cooled. For example, a temperature sensor may be position to measure a temperature inside the space to be cooled, and may send a signal based on the measurements once a desired temperature is reached to stop cooled air being provided within the space.

Advantageously, modifying the target temperature to the first, default, target temperature T₁ in response to a user input may allow for cooling to be provided only while desired by a user.

Optionally, alternatively or additionally, modifying the target temperature to the first, default, target temperature T₁ may be in response to the water in the water tank being at, or near, the second target temperature T₂. Once the second target temperature T₂ has been reached, no more heat energy may be stored in the water, thus it may be advantageous to revert back to the first, default, target temperature T₁ to allow for the cool boost to be provided again when desired. The target temperature of water in the water tank being modified from the second target temperature T₂ to the first, default, target temperature T₁ in response to the water in the water tank being at, or near, the second target temperature T₂ may be an example of modifying the target temperature of water in the water tank to the first, default, target temperature T₁ in response to a signal from a, or the, sensor, in particular a, or the, temperature sensor, or a, or the, controller. In this case, the signal may be a signal from a temperature sensor configured to measure a temperature of the water in the water tank.

In some embodiments, the target temperature of water in the water tank may be modified from the second target temperature, T₂, to the first, default, target temperature T₁ automatically, or the target temperature of water in the water tank may be modified from the second target temperature, T₂, to the first, default, target temperature T₁ manually.

The target temperature of water in the water tank being modified to the first, default, target temperature T₁ after a set time period and/or in response to a signal from a, or the, sensor, in particular a, or the, temperature sensor or a, or the, controller, may be referred to as the target temperature of water in the water tank being modified automatically. The target temperature of water in the water tank being modified to the first, default, target temperature T₁ in response to a user input may be referred to as the target temperature of water in the water tank being modified manually.

Advantageously, automatically modifying the target temperature of water in the water tank back to the first, default, target temperature T₁ may allow for the “cool boost” to be provided again when desired. It may also prevent user error, e.g. a user forgetting to revert the target temperature back to the first, default, target temperature T₁.

In some embodiments, the signal may be a signal from a temperature sensor (or from a controller communicatively coupled to a temperature sensor) configured to sense a temperature of at least one of: exhaust air from the heat pump; incoming air being received by the heat pump; and air in a room to which exhaust air from the heat pump is provided.

In some embodiments, the sensor may comprise, or be, another kind of sensor, such as a humidity sensor.

The second target temperature T₂ may be about 60° C. to about 90° C., or about 65° C. to about 75° C., or about 70° C. Advantageously, a second target temperature of T₂ in this range, or of about 70° C., is sufficiently higher than the first, default, target temperature to provide a sufficient cooling “boost”, while minimising wear caused by high temperatures. Further advantageously, the temperature in the water tank increasing to at least about 60° C. also prevents growth of Legionella bacteria.

The first, default, target temperature T₁ may be about 40° C. to about 60° C., or about 45° C. to about 55° C. For example, the first target temperature T₁ may be about 50° C., or about 55° C. Such a first, default, target temperature T₁ may be suitable to provide heated water for a heating system or other household needs, while being low enough to allow for a sufficient cooling “boost” when the target temperature is modified.

The method may further comprise: upon modifying the target temperature to the second target temperature T₂, modifying a flow rate of the air from a first flow rate, FR₁, to a second flow rate, FR₂, wherein FR₂>FR₁. Advantageously, by increasing a flow rate of the air, a temperature of the cooled exhaust air being used for cooling may be increased, thus allowing for the cooled air to be provided at a pleasant temperature.

For example, during normal operation of the heat pump (i.e., in heat pump mode, where the target temperature is T₁, and the heat pump is configured to provide heated water), exhaust air from the heat pump may be at a temperature of about 5° C. If exhaust air at such a temperature is provided to cool a space, it may be unpleasant. As such, by increasing a flow rate, the temperature of the exhaust air may increase, e.g. to about 20° C., thus providing the exhaust air for cooling at a more pleasant temperature.

The method may further comprise: upon modifying the target temperature (back) to the first, default, target temperature T₁, modifying a flow rate of the air from a second flow rate, FR₂, to a first, default, flow rate, FR₁, wherein FR₂>FR₁.

According to a second aspect of the present disclosure, there is provided a system for providing cooled air, using a heat pump configured to provide heated water. The system comprises: a first air inlet for receiving air at a first air temperature T₃; a heat pump, in fluid communication with the first air inlet, for extracting heat energy from the air; a water tank for storing the extracted heat energy as heat energy in water in the water tank; a first air outlet, in fluid communication with the heat pump, for providing cooled air, the cooled air being at a second air temperature T₄, where T₄<T₃; and a controller, configured to modify a target temperature of water in the water tank from a first, default, target temperature T₁ to a second target temperature, T₂, where T₁<T₂.

By providing a controller configured to modify a target temperature of water in the water tank to a higher, second target temperature T₂, an effective capacity of the heat sink (i.e., the water tank) to store heat is increased, thus allowing for more “exhaust” cooled air to be produced than would otherwise be the case.

Advantageously, the system thus allows for a prolonged cooling effect to be achieved using “waste” or “exhaust” cooled air, while storing the extracted heat energy in the water in the water tank, to provide heated water.

The heat pump may be referred to as an air source heat pump.

It is noted that the controller may be configured to modified the target temperature only temporarily. In other words, the system may be configured to provide heated water, the heat pump being configured to continuously operate to heat water. Upon the controller modifying the target temperature, the water in the water tank may be at, or near, the target temperature. Temporarily modifying the target temperature (temporarily) increases the effective capacity of the heatsink (the water tank) to store heat energy, thus permitting cooled air to be provided for longer.

The controller may further be configured to receive a trigger signal, and to modify the target temperature of water in the water tank responsive to the trigger signal. Advantageously, receiving a trigger signal may allow for prolonged cooling to be provided when required, or on demand.

The system may further comprise at least one of: a user input device for generating the trigger signal; a sensor for generating the trigger signal, in particular a temperature sensor; and a controller for generating the trigger signal in response to measurements of a sensor, in particular a temperature sensor.

The user input device may be a button, or a touch screen, or an application on a mobile device. The temperature sensor may be provided to measure a temperature inside an apartment, of the incoming air being received, or of the cooled exhaust air being provided.

The controller may be further configured to receive a further trigger signal, and to, in response to the further trigger signal, modifying the target temperature of water in the water tank from the second target temperature, T₂, to the first, default, target temperature T₁. Advantageously, this may allow for cooling to be provided for a limited amount of time, e.g. as desired, and for the cool boost to be available again when desired, once the temperature of the water in the water tank has fallen below the second target temperature, T₂. It is apparent that the greater the difference between the temperature of the water in the water tank and the second target temperature, the more additional heat may be stored, and cooling may be provided, by the system.

Optionally, the system is configured to receive the further trigger signal from a, or the, user input device. A further trigger signal being received from a user input device may be referred to as a manual further trigger signal.

Optionally the system is configured to receive the further trigger signal from a, or the, sensor or from a, or the, controller. Alternatively or additionally, the system may further comprise a timer, and the system is configured to receive the further trigger signal from the timer. A further trigger signal received from a, or the, sensor, a, or the, controller, or a timer may be referred to as an automatic further trigger signal.

In some embodiments, a, or the, sensor (or a controller to which the sensor is communicatively coupled) may be configured to generate the further trigger signal, the sensor being configured to measure a temperature of at least one of: the water in the water tank; exhaust air from the heat pump; incoming air being received by the heat pump; and air in a room to which exhaust air from the heat pump is provided.

Advantageously, providing a timer may allow for cooled air to be provided for a predetermined amount of time, e.g. a known amount of time sufficient to cool a space to be cooled. Providing a user input device may allow for cooling to be provided only while desired by a user.

Alternatively or additionally, the system may comprise a temperature sensor for measuring a temperature of water in the water tank. The controller may be configured to receive a measurement of a temperature of water in the water tank, and upon water in the water tank being at, or near, the second target temperature T₂, to modify the target temperature (back) to the first, default, target temperature T₁. In some embodiments, the temperature sensor for measuring a temperature of water may be the sensor which generates (or, in response to the input of which the controller, generates) the automatic further trigger signal.

The second target temperature T₂ may be about 60° C. to about 90° C., or about 65° C. to about 75° C., or about 70° C. Advantageously, a second target temperature of T₂ in this range, or of about 70° C., is sufficiently larger than the first, default, target temperature to provide a sufficient cooling “boost”, while minimising wear caused by high temperatures.

The first, default, target temperature T₁ may be about 40° C. to about 60° C., or about 45° C. to about 55° C. For example, the first target temperature T₁ may be about 50° C., or about 55° C. Such a first, default, target temperature T₁ may be suitable to provide heated water for a heating system or other household needs, while being low enough to allow for a sufficient cooling “boost” when the target temperature is modified.

The system may further comprise a second air inlet, in fluid communication with the heat pump, wherein the second air inlet is without a space to be cooled, and the first air inlet is within the space to be cooled. The first air inlet may allow for air to be taken from within a space to be cooled, thus removing hot air, whereas the second air inlet prevents air from being removed from an inside when running heat pump in normal operation, when the temperature in the space is pleasant.

The system may further comprise a second air outlet, in fluid communication with the heat pump, wherein the second air outlet is without a space to be cooled, and the first air outlet is within the space to be cooled. The second air outlet may allow for exhaust (cooled) air to be exhausted without the space, preventing cooled air from cooling a space when it is undesirable.

The system may further comprise a manifold for controlling air flow between the air inlets, the air outlets, and the heat pump. The manifold may be configurable to selectively allow air flow from one of the first air inlet and the second air inlet to the heat pump and/or to selectively allow air flow from the heat pump to one of the first air outlet and the second air outlet.

The manifold may be configurable between a first configuration, in which the manifold permits air flow between the first air inlet, the heat pump, and the first air outlet, and a second configuration, in which the manifold permits air flow between the second air inlet, the heat pump, and the first air outlet.

The controller may be further configured to reconfigure the manifold from the first configuration to the second configuration upon modifying the target temperature of water in the water tank from the first, default, target temperature T₁ to the second target temperature T₂.

Advantageously, by changing from receiving air from without the space to within the space upon the target temperature being modified, hot air within the space to be cooled is extracted, thus removing hot air and replacing it with cooled air. This may improve an efficiency of the cooling.

Indeed, by changing from providing air to an outside air outlet to an outside air outlet upon the target temperature being modified, cooled air may only be provided when desired, rather than being provided at all times when the heat pump is running. In particular when the heated water is used for heating a space, providing the cooled air to the space at the same time is counterproductive. This situation may be avoided by having a manifold having two configurations.

It is noted that other configurations may be possible, e.g. connecting more than one inlet and/or one outlet to the manifold simultaneously, in any combination.

It is noted that in the system where there is no changing from an outside air outlet to an inside air inlet, the air may always be provided to an inside air inlet.

The at least one manifold may comprise at least one of: a control damper per air inlet and a control damper per air outlet; a rotary valve; and an isolation valve.

Advantageously, control dampers may allow for partial occlusion, thus allowing for incoming air to be received from the inlets, and cooled exhaust air to be provided to the outlets, in specific proportions. Advantageously, a rotary valve may allow for a single valve to control air flows. Advantageously, isolation valve may allow for air inlets and air outlets to be shut off completely, which may provide improved control of air flows.

The system may further comprise an actuator for actuating the manifold. Advantageously, providing a single actuator for actuating the manifold may reduce moving parts and allow for improved control.

The controller may further be configured to control the actuator.

The system may comprise an apparatus for providing cooled air, the apparatus comprising the first air inlet; the second air inlet; the first air outlet; the second air outlet; and the manifold. When the system comprises an actuator, the apparatus comprises the actuator. The apparatus may further comprise the controller. Advantageously, by providing these components of the system in an apparatus for providing cooled air, they may be arranged in an efficient way and may be retrofittable, or replaceable as a whole. The “apparatus for providing cooled air” may be referred to as a head unit, or header.

The system may further comprise a fan for creating flow of the air.

The controller may be further configured to modify a flow rate of the air from a first flow rate, FR₁, to a second flow rate, FR₂, wherein FR₂>FR₁, upon modifying the target temperature of water in the water tank from the first, default, temperature T₁ to the second temperature, T₂. This may be achieved by increasing a speed of the fan. Advantageously, by increasing a flow rate of the air, a temperature of the exhausted cooled air being used for cooling may be increased, thus allowing for the cooled air to be provided at a pleasant temperature.

The system may be configured to be coupled to a mechanical extract ventilation system. Advantageously, in this way, the system may make use of ducts of a mechanical extract ventilation (MEV) system without the need to install further ducts.

A, or the, temperature sensor may form part of the MEV system, and the controller may be configured to receive measurements from the temperature sensor. In this way, the ducts of the MEV system may be used for providing cooled air, while also providing information required to control the provision of cooled air.

Alternatively, the system may comprise a MEV system.

The water tank may be a standard water tank for domestic use. As such, a volume of the water tank may be about 100 litres to about 500 litres, or about 150 litres to about 400 litres, for example, a volume of the water tank may be about 160 litres, or about 200 litres, or about 230 litres, or about 300 litres.

The water tank may comprise a water inlet for receiving unheated water from mains, and a water outlet for providing heated water to a heating system or to end user water outlets such as taps.

The system may further comprise a mixer valve, connected to the water outlet. Advantageously, the mixer valve may allow for heated water to be provided from the water tank at a suitable temperature, even if the temperature of water in the water tank is above a suitable temperature, e.g. because the target temperature has been increased to T₂.

The heat pump may be a KERS The Weatherby™ heat pump.

The heat pump may have an efficiency of over 300%, e.g. of about 350%, as determined according to the Standard Assessment Procedure (SAP).

The heat pump may require an electrical power input of about 450 W, e.g. 462 W, and may provide a power output of about 2000 W, e.g. 2010 W.

The heat pump may comprise refrigerant R134A, or any other suitable refrigerant.

The heat pump may be heaterless, i.e. it may not comprise an immersion heater.

According to a third aspect of the present disclosure, there is provided an apparatus for providing cooled air, configured to be used in a system according to the second aspect, the apparatus comprising: a first air inlet; a second air inlet; a first air outlet; a second air outlet, each of the first air inlet, the second air inlet, the first air outlet, and the second air outlet configured to be in fluid communication with a heat pump configured to provide heated water; and a manifold for controlling air flow between the air inlets, the air outlets, and the heat pump.

The second air inlet and the second air outlet are without a space to be cooled, and the first air inlet and the first air outlet are within the space to be cooled.

The manifold may be configurable to selectively allow air flow from one of the first air inlet and the second air inlet to the heat pump and/or for selectively allowing air flow from the heat pump to one of the first air outlet and the second air outlet.

The manifold may further be configurable between a first configuration, in which the manifold permits air flow between the first air inlet, the heat pump, and the first air outlet, and a second configuration, in which the manifold permits air flow between the second air inlet, the heat pump, and the first air outlet.

The at least one manifold may comprise at least one of: a control damper per air inlet and a control damper per air outlet; a rotary valve; and an isolation valve. Advantageously, control dampers may allow for partial occlusion, thus allowing for air to be received, and provided, in specific proportions. Advantageously, a rotary valve may allow for a single valve to control receiving and providing of air. Advantageously, isolation valve may allow for air inlets and outlets to be shut off completely, which may provide improved control of air flows.

The apparatus may further comprising at least one of: an actuator for actuating the manifold; and a controller for controlling the manifold. Advantageously, providing an actuator for actuating the manifold may facilitate controlling the air flow.

The controller may further be configured to modify a target temperature of water in a water tank from a first, default, target temperature T₁ to a second target temperature, T₂, where T₁<T₂.

The controller may further be configured to reconfigure the manifold from the first configuration to the second configuration upon modifying the target temperature of water in the water tank from the first, default, target temperature T₁ to the second target temperature, T₂.

The apparatus may be configured to be retrofittable to a heat pump configured to provide heated water.

It will be appreciated that features described in relation to one aspect of the present disclosure may also be applied equally to all of the other aspects of the present disclosure. Features described in relation to the first aspect of the present disclosure may be applied equally to the second aspect of the present disclosure and vice versa. For example, features of the method described in relation to the first aspects may be applied, mutatis mutandis, to the system of the second aspect or the apparatus of the third aspect. For example, the controller of the system may be configured to carry out the method steps described in relation to the first aspect, where appropriate.

It will further be appreciated that particular combinations of the various features described and defined in any aspects of the invention may be implemented and/or supplied and/or used independently.

### BRIEF DESCRIPTION OF DRAWINGS

The disclosure will be further described, by way of example only, with reference to the accompanying drawings, in which:

FIG. 1 shows a schematic overview of an example system for providing cooled air;

FIG. 2 shows a schematic overview of a further example system for providing cooled air;

FIG. 3 shows a front view of a water tank for use in the example system of FIG. 1 or 2;

FIGS. 4A to 4C show isometric, top and side views of an apparatus for providing cooled air, or header, for use in the example system of FIG. 1 or 2;

FIGS. 5A and 5B show schematic overviews of an example apparatus, or header, for providing cooled air in a first and second configuration;

FIGS. 6A and 6B show schematic overviews of a further example apparatus, or header, for providing cooled air in a first and second configuration;

FIG. 7 shows a flow diagram of an example method for providing cooled air;

FIG. 8 shows a flow diagram of a further example method for providing cooled air; and

FIG. 9 shows a flow diagram of a further example method for providing cooled air.

### DETAILED DESCRIPTION OF DRAWINGS

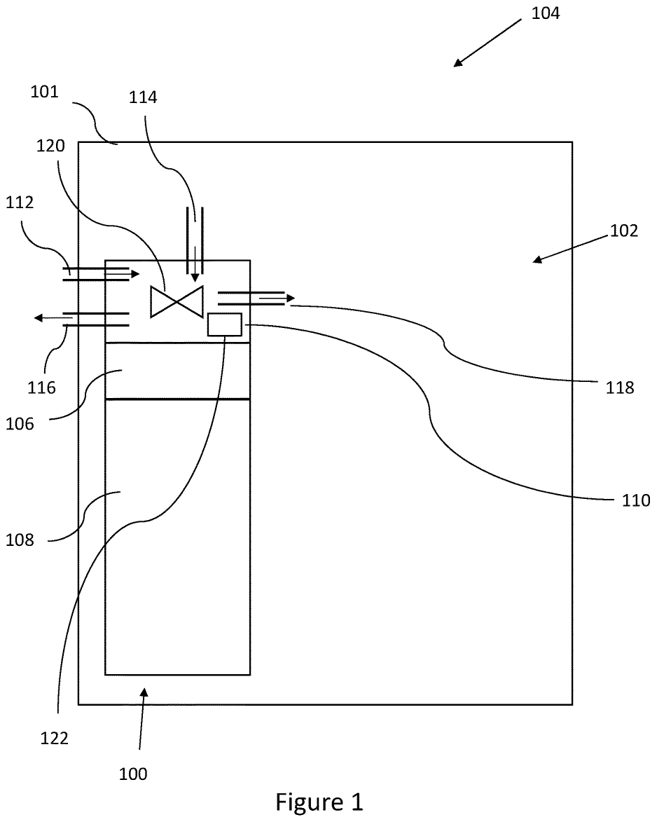

FIG. 1 shows an overview of a system 100 for providing cooled air. The system 100 may provide cooled air to a space 101 to be cooled defined by a boundary. In this example, the space 101 to be cooled is an apartment 101. However, the space 101 may be any other domestic or commercial space which may require cooling.

The boundary of the space 101 defines an inside 102 of the space, i.e. anything on the inside 102 is within the space, and an outside 104 of the space 101, i.e. anything on an outside 104 is without the space 101.

The system 100 comprise an air source heat pump 106. The air source heat pump 106 may be a conventional air source heat pump, and comprises a refrigerant circuit including an evaporator, a compressor, a heat exchanger, and an expansion valve (not shown in detail).

The heat pump 106 is configured to heat water in a water tank 108 of the system 108. The heat pump 106 receives air from an apparatus 110 for providing cooled air, or header 110. The header 110 comprises an outside air inlet 112, allowing flow of air from the outside 104 (or without) the space 101, and an inside air inlet 114, allowing flow of air from the inside 102 (or within) the space 101. The header also has an outside air outlet 116, allowing for flow of air to the outside 104 (or without) the space 101, and an inside air outlet 118, allowing for flow of air to the inside 102 (or within) the space 101.

As the air source heat pump 106, like any conventional air source heat pump 106, extracts heat energy from the air, the “exhaust” air being provided to the outside air outlet 116 or the inside air outlet 118 will be cooler than the incoming air received via the outside air inlet 112 or inside air inlet 114. In other words, an air temperature T₃ of the incoming air is higher than an air temperature T₄ of the cooled “exhaust” air.

The header 110 comprises a manifold 120, configured to control which air inlet 112, 114 the heat pump 106 received heat from, and to which air outlet 116, 118 the cooled “exhaust” air is provided. The manifold 120 will be described in more detail below.

The system 100, specifically the header 110, further comprises a controller 122, configured to modify a target temperature of water in the water tank 108 from a first, default, target temperature T₁ to a second target temperature, T₂, where T₁<T₂.

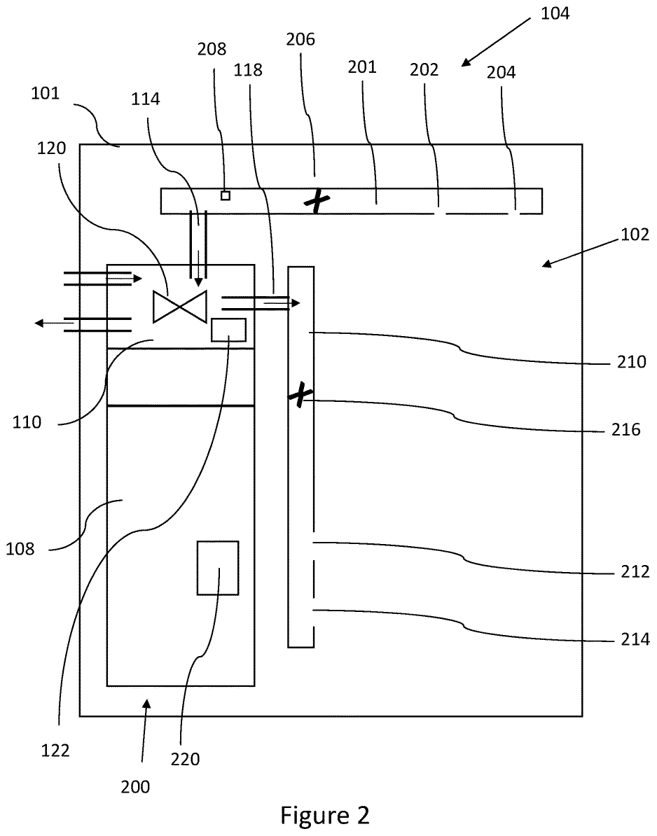

As shown in FIG. 2, in a second example system 200, the inside air inlet 114 may be connected to an inlet duct 201. The inlet duct 201 comprises two duct inlets 202, 204. The duct inlets 202, 204 are provided in areas of the apartment 101 which are most susceptible to overheating, or excessive moisture. In this example, the duct inlet 202 is provided in a kitchen, and the duct inlet 204 is provided in a bathroom.

A fan 206 for forcing air flow from the duct inlets 202, 204 towards the inside air inlet 114 is provided in the inlet duct 201.

A temperature sensor 208 is provided in the inlet duct 201 for measuring an air temperature T₃ of the incoming air.

Similarly, the inside air outlet 118 may be connected to an outlet duct 210, the outlet duct 210 having two duct outlets 212, 214. The duct outlets 212, 214 are provided in areas of the apartment 101 which are susceptible to overheating. Alternatively, the duct outlets 212, 214 may be provided in areas of the apartment 101 other than those susceptible to overheating, to create air flow within the apartment from the duct outlets 212, 214 towards the duct inlets 202, 204. A further fan 216 for forcing air flow from the inside air outlet 118 towards the duct outlets 212, 214 is provided in the outlet duct 210.

In the example of FIG. 2, the inlet duct 201 and outlet duct 210 are part of the system 200. In other examples, the inlet duct 201 and the outlet duct 210 may be a part of a separate mechanical extract ventilation (MEV) system to which the system 200 is connected.

It is noted that only one of the inlet duct 201 and the outlet duct 210 may be provided, and that the inlet duct 201 and the outlet duct 210 may be provided with or without the fans 206, 216 or the temperature sensor 208.

The system 200, specifically the header 110, further comprises a controller 122, configured to modify a target temperature of water in the water tank 108 from a first, default, target temperature T₁ to a second target temperature, T₂, where T₁<T₂.

The controller 122 is further configured to receive a measurement from the temperature sensor 208 and a signal from a user input device. The user input device is a touchscreen panel 220. The controller 122 is configured to modify the target temperature from T₁ to T₂ in response to a trigger signal from the temperature sensor 208, or the touchscreen panel 220.

At the same time as modifying the target temperature, the controller 122 is further configured to control the manifold 120 to switch from receiving incoming air from the outside air inlet 112 and providing cooled exhaust air to the outside air outlet 116, to receiving incoming air from the inside air inlet 114 and providing cooled exhaust air to the outside air outlet 118.

The controller 122 is further configured to increase a fan speed of one of the fans 206, 216 upon modifying the target temperature from T₁ to T₂.

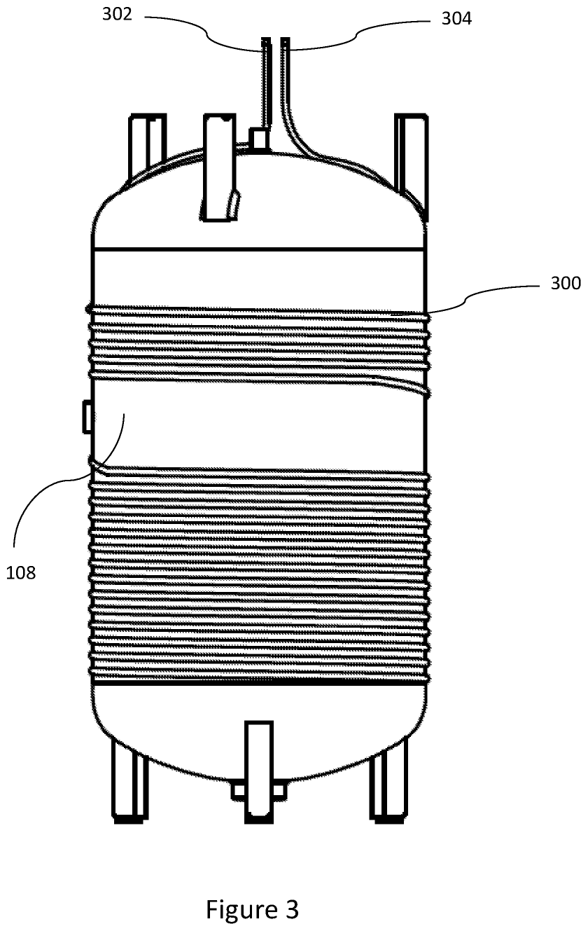

FIG. 3 shows a side view of a water tank 108. A refrigerant conduit 300 is wrapped around the water tank 108, the refrigerant conduit 300 extending between a refrigerant inlet 302 and a refrigerant outlet 304. Refrigerant heated by the heat pump 106 using heat energy from the incoming air is provided via the refrigerant inlet 302, to heat water in the water tank 108. Once heat has been exchanged from the refrigerant to the water in the water tank 108, cooler refrigerant is output via the refrigerant outlet 304.

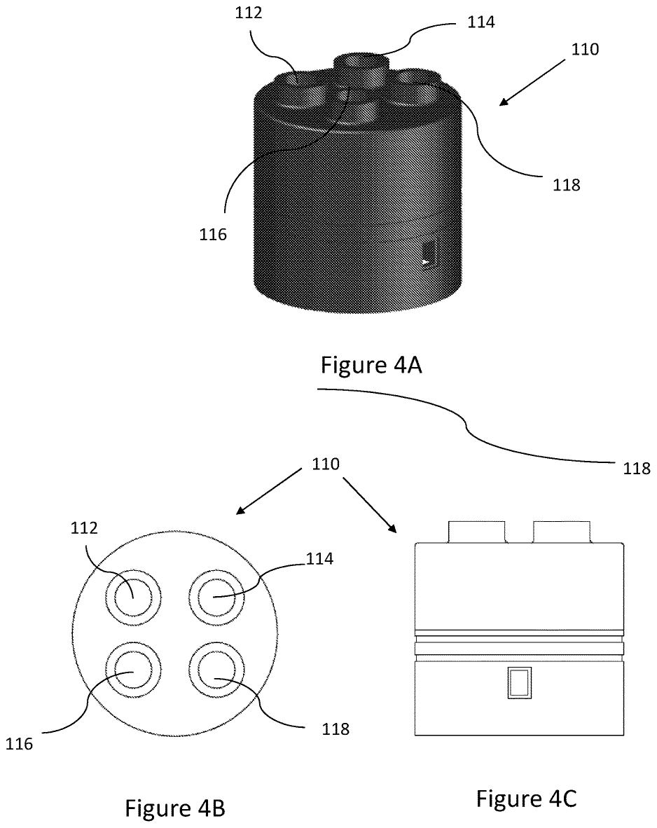

FIG. 4A shows an isometric view of the header 110. In the header 110, the air inlets 112, 114 and air outlets 116, 118 are provided on a top side of the header 110, as shown in FIG. 4B.

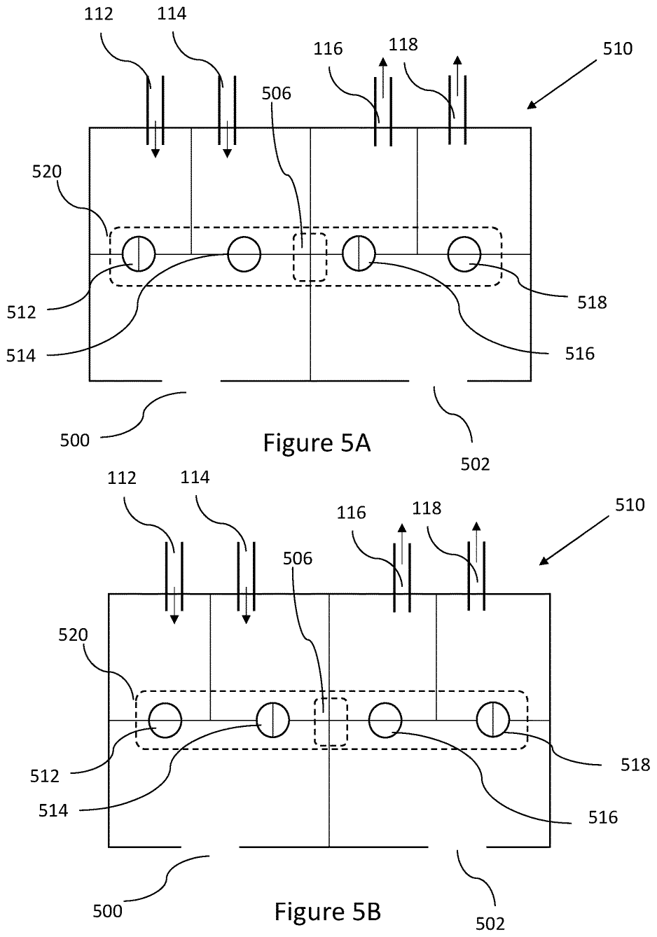

FIGS. 5A and 5B show the internal features of an example header 510 in two different configurations. The header 510 comprises a manifold 520, the manifold 520 having four valves 512, 514, 516, 518. Each of the valves 512, 514, 516, 518 is associated with one of the air inlets 112, 114 or air outlets 116, 118.

The header 510 comprises a header outlet 500 for providing incoming air at an air temperature T₃ to the heat pump 106, and an header inlet 502 for receiving cooled exhaust air at an air temperature T₄ from the heat pump 106, where T₄<T₃.

As shown in FIG. 5A, in a first configuration of the manifold 520, valves 512 and 516 are open, and valves 514 and 518 are closed, thus allowing air flow from the outside air inlet 112 through the valve 512 and header outlet 500 to provide air to the heat pump 106, and further to allow exhaust air flow from the heat pump 106 through the header inlet 502 and the valve 516 to the outside air outlet 116. The first configuration of the manifold 520 may be referred to as a default configuration, or a normal operation configuration, as it is the configuration during normal operation of the heat pump 106, i.e. when the heat pump provides heated water and exhausts cooled air to the outside 104.

In a second configuration, as shown in FIG. 5B, valves 512 and 516 are closed, and valves 514 and 518 are open, thus allowing air flow from the inside air inlet 114 through the valve 514 and header outlet 500 to provide incoming air to the heat pump 106, and further to allow exhaust air flow from the heat pump 106 through the header inlet 502 and the valve 516 to the outside air outlet 116.

It is noted that the manifold 520 may enable further configurations, such as a configurations in which both valves 512 and 514 are open to permit incoming air flow from the air inlets 112, 114 to the header outlet 500 and/or in which both valves 516 and 518 are open to permit exhaust air flow from the header inlet 502 to the air outlets 116, 118. The manifold 520 may also enable further configurations in which valves 512 and 518 are open, or in which valves 514 and 516 are open.

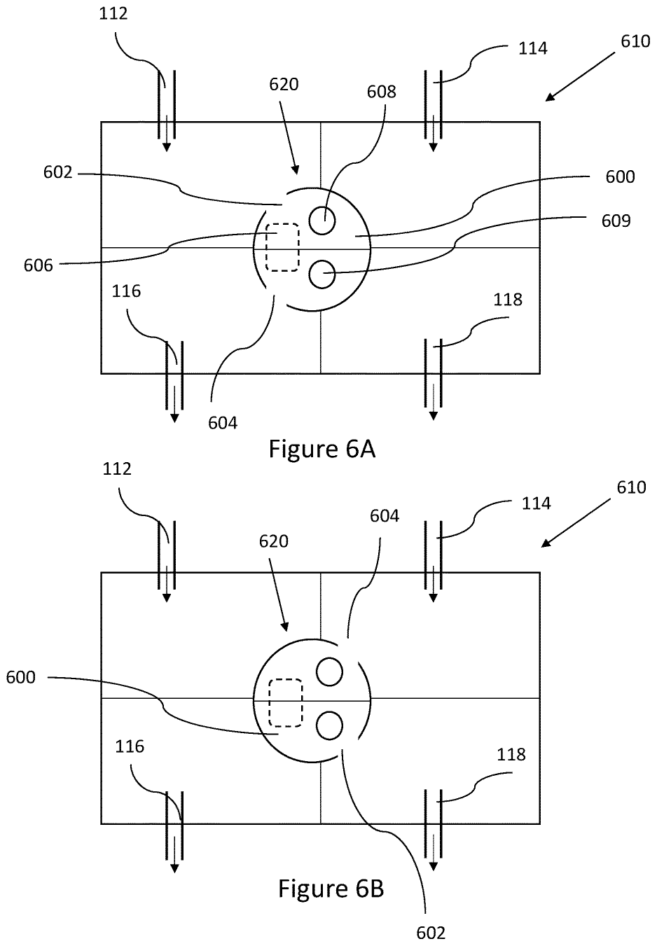

The manifold 520 further comprises an actuator 506, which may be controlled by the controller 122. The actuator is configured to control the valves to simultaneously change one of valves 512 and 514 from open to closed and the other of valves 512 and 514 from closed to open. The actuator may comprise a single actuator, or may comprise two actuators, one to actuate valves 512 and 514 and another to actuate valves 516 and 518. FIGS. 6A and 6B show the internal features of another example header 610 in two different configurations. The header 610 comprises a manifold 620, the manifold 620 having a rotary valve 600.

The rotary valve 600 comprises a first opening 602 and a second opening 604, allowing air flow into and out of the rotary valve 600. The manifold 620 further comprises an actuator 606 configured to rotate the rotary valve 600. The rotary valve 600 further has a first header opening 608 and a second header 609, fluidically connected to the heat pump 106.

In a first configuration shown in FIG. 6A, the rotary valve 600 is positioned to allow incoming air flow from an outside air inlet 112 into the rotary valve 600 via the first opening 602, and to the heat pump 106 via the first header opening 608, and exhaust air flow from the heat pump 106 through the second header opening 609, out of the second opening 604, and to the outside air outlet 116. The first configuration of the manifold 620 may be referred to as a default configuration, or a normal operation configuration, as it is the configuration during normal operation of the heat pump 106, i.e. when the heat pump 106 provides heated water and exhausts cooled air to the outside 104.

As shown in FIG. 6B, in a second configuration, the rotary valve 600 is positioned to allow incoming air flow from the inside air inlet 114 through the second valve opening 604 and to the heat pump 106 via the first header opening 608, and exhaust air flow from the heat pump 106 through the second header opening 609, out of the first valve opening 602, and to the inside air outlet 118.

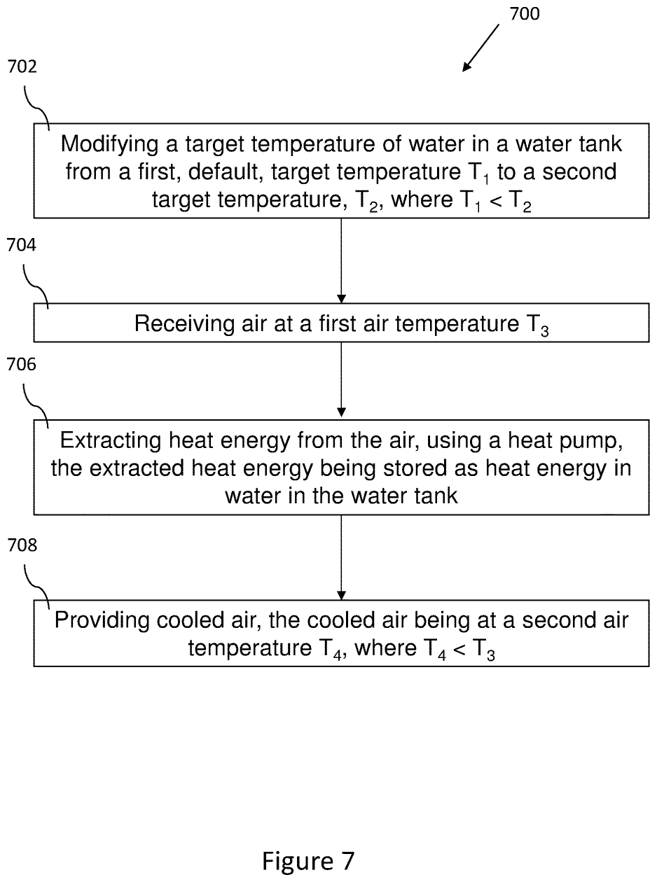

FIG. 7 shows a flow diagram of an example method 700 for providing cooled air.

The method 700 begins with a step of modifying 702 a target temperature of water in a water tank from a first, default, target temperature T₁ to a second target temperature, T₂, where T₁<T₂. Modifying a target temperature of water in the water tank 108 increases an effective capacity of the water in the water tank 108 to store heat energy.

The method 700 continues by receiving 704 incoming air at a first air temperature T₃. The method 700 further comprises a step of extracting 706 heat energy from the air, using the heat pump 106, the extracted heat energy being stored as heat energy in water in the water tank 108.

Finally, the method 700 comprises a step of providing 708 cooled air, the cooled air being at a second air temperature T₄, where T₄<T₃. Owing to the increased capacity of the water in the water tank 108 to store heat energy, the step of providing 708 cooled air may be carried out for longer than would otherwise be possible.

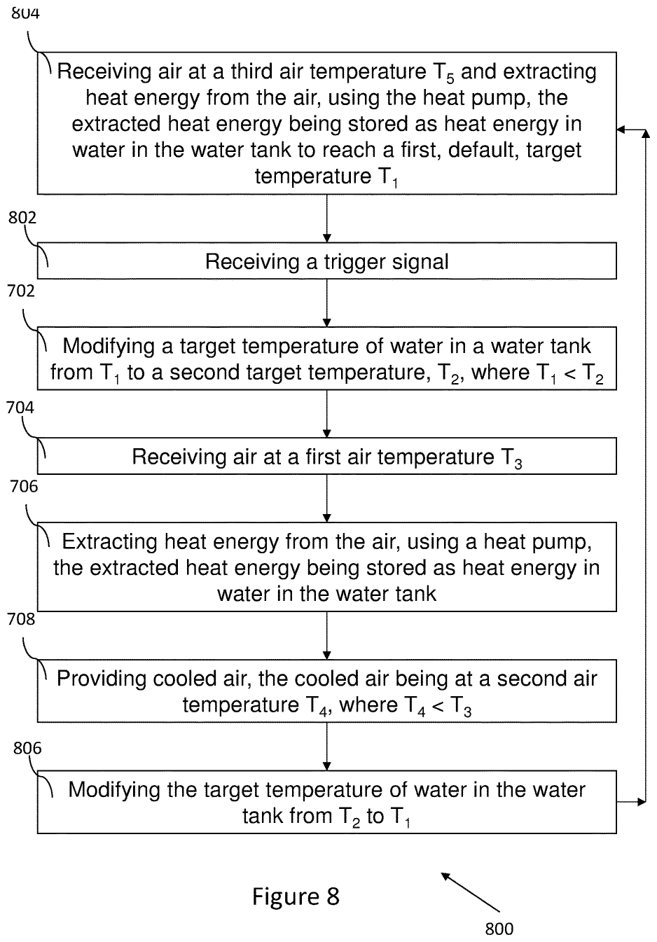

FIG. 8 shows a flow diagram of a further example method 800 for providing cooled air. The further example method 800 comprises the steps 702, 704, 706 and 708 of the method 700. In addition, the method 800 further comprises a step of receiving 802 a trigger signal. In response to receiving 802 the trigger signal, e.g. from the temperature sensor 208, or a user via the touchscreen panel 220, the target temperature is modified in step 702.

As the method 800 relates to a method of providing cooled air, using a heat pump 106 configured to provide heated water, before the step 702 is carried out, the heat pump 106 may already be operating to provide heated water. In this case, the method 800 further comprises a step of receiving 804 air at a third air temperature T₅ and extracting heat energy from the air, using the heat pump, the extracted heat energy being stored as heat energy in water in the water tank to reach a first, default, target temperature T₁.

Step 804 may be carried out while a temperature of the water in the water tank is less than T₁.

Finally, method 800 further comprises a step of modifying 806 the target temperature of water in the water tank from T₂ to T₁. Step 806 may be performed in response to receiving a further trigger signal. Step 806 may be in response to a measurement from the temperature sensor 208, or from the touchscreen panel 220.

It is noted that the method may comprise only one, or two, of the additional steps 802, 804, and 806, in any combination.

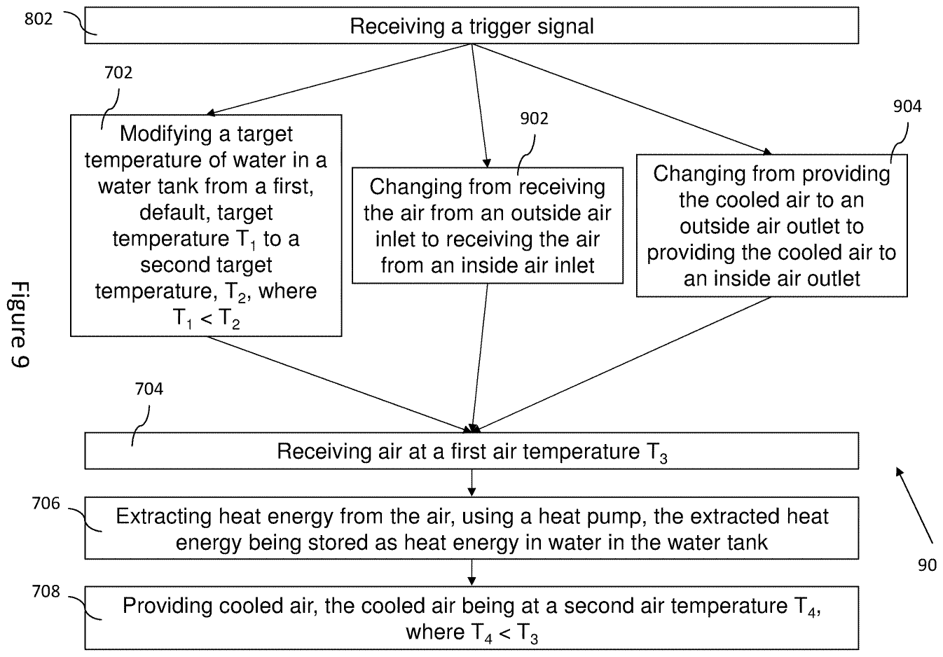

FIG. 9 shows a flow diagram of a further example method 900 for providing cooled air. The further example method 900 comprises the steps 702, 704, 706 and 708 of the method 700. The method 900 further comprises step 802 of the method 800.

In addition, the method 900 further comprises a step of changing 902 from receiving the air from the outside air inlet 112 to receiving the air from the inside air inlet 114. The method 900 further comprises a step of changing 904 from providing the cooled exhaust air to the outside air outlet 116 to providing the cooled exhaust air to the inside air outlet 118.

As shown in FIG. 9, steps 702, 902, and 904 may be carried out, substantially, concurrently, in response to receiving 802 a trigger signal. However, steps 902 and 904 may also be carried out upon step 702 being carried out, i.e. as in response to modifying 702 a target temperature.

Not shown in FIG. 9, but possibly also, substantially, concurrently with step 702, the method 900 may further comprise a step (step X) of modifying a flow rate of the air from a first flow rate, FR₁, to a second flow rate, FR₂, wherein FR₂>FR₁. This may be achieve by increasing a speed of at least one of the fans 206 and 216.

The controller 122 may be configured to carry out at least some of the steps of methods 700, 800, and 900, in particular some of steps 702, 802, 806, 902, and X.

Only some of the additional steps of method 800 or method 900 may be provided together with the steps of method 700, for example, any one or more of steps 802, 804, 806, 902, 904 and X may be provided together, or alone, or in any combination.

In use, the system 100 or the system 200 may be configured to carry out one of the methods 700, 800, 900. In particular, during “normal operation”, the system 100, 200 may be configured so that the manifold 120 allows incoming air from the outside air inlet 112 to be provided to the heat pump 106 to provide heat energy for heating water in the water tank 108. Exhaust air is provided to the outside air outlet 116.

Upon receipt of a trigger signal, which may be received from a user via touchscreen panel 220, or via other means such as an application on a mobile device, or which is generated in response to e.g. a maximum temperature in the apartment 101 being reached, the manifold 120 is reconfigured to a second configuration by the actuator 506, 606 in response to commands by the controller 122, so that the manifold 120 allows incoming air from the inside air inlet 114 to be provided to the heat pump 106 to provide heat energy for heating water in the water tank 108. Cooled exhaust air is provided to the inside air outlet 118, thus providing cooling within the apartment 101, optionally via duct 210.

Also upon receipt of the trigger signal, the controller 122 modifies a target temperature of water in the water tank 118 from a first, default, target temperature T₁ (being between 50° C. and 55° C.) to a second target temperature, T₂ (being 70° C.). Concurrently, a speed of the fan 206 is increased.

Once a sensed temperature in the space 101 reaches a set level, or a user inputs a command via the user input device 220, the controller 122 modifies a target temperature of water in the water tank 118 from the second target temperature, T₂ (being 70° C.) back to the first, default, target temperature T₁ (being between 50° C. and 55° C.). Concurrently, the controller also reconfigured the manifold 510, 610 back to the default configuration, and reduced the fan speed back to a default speed.

1-31. (canceled)

32. A method for providing cooled air, using a heat pump configured to provide heated water, the method comprising:
modifying a target temperature of water in a water tank from a first, default, target temperature T₁ to a second target temperature, T₂, where T₁<T₂;
receiving air at a first air temperature T₃;
extracting heat energy from the air, using a heat pump, the extracted heat energy being stored as heat energy in water in the water tank; and
providing cooled air, the cooled air being at a second air temperature T₄, where T₄<T₃.

33. A method according to claim 32, further comprising:
receiving a trigger signal, wherein modifying the target temperature of water in the water tank is in response to the trigger signal; optionally wherein the trigger signal is generated by at least one of:
a user;
a sensor, in particular a temperature sensor; and
a controller in response to measurements of a sensor, in particular a temperature sensor.

34. A method according to claim 32, further comprising:
upon modifying a target temperature of water in a water tank, changing from receiving the air from an outside air inlet to receiving the air from an inside air inlet, wherein the outside air inlet is without a space to be cooled, and the inside air inlet is within the space to be cooled.

35. A method according to claim 32, further comprising:
upon modifying a target temperature of water in a water tank, changing from providing the cooled air to an outside air outlet to providing the cooled air to an inside air outlet, wherein the outside air outlet is without a, or the, space to be cooled, and the inside air outlet is within the space to be cooled.

36. A method according to claim 32, further comprising:
modifying the target temperature of water in the water tank from the second target temperature, T₂, to the first, default, target temperature T₁; and
optionally wherein the target temperature of water in the water tank is modified from the second target temperature, T₂, to the first, default, target temperature T₁ in response to a user input.

37. A method according to claim 36, wherein the target temperature of water in the water tank is modified to the first, default, target temperature T₁:
after a set time period; and/or
in response to a signal from a, or the, sensor, in particular a, or the, temperature sensor or a, or the, controller, and,
optionally, wherein the signal is a signal from a sensor configured to measure a temperature, or a controller communicatively coupled to a sensor configured to measure a temperature, of at least one of:
the water in the water tank;
exhaust air from the heat pump;
incoming air being received by the heat pump; and
air in a room to which exhaust air from the heat pump is provided.

38. A method according to claim 32, wherein the second target temperature T₂ is about 60° C. to about 90° C. and/or wherein the first, default, target temperature T₁ is about 40° C. to about 60° C.

39. A method according to claim 32, further comprising:
upon modifying the target temperature to the second target temperature T₂, modifying a flow rate of the air from a first flow rate, FR₁, to a second flow rate, FR₂, wherein FR₂>FR₁.

40. A system for providing cooled air, using a heat pump configured to provide heated water, the system comprising:
a first air inlet for receiving air at a first air temperature T₃;
a heat pump, in fluid communication with the first air inlet, for extracting heat energy from the air;
a water tank for storing the extracted heat energy as heat energy in water in the water tank;
a first air outlet, in fluid communication with the heat pump, for providing cooled air, the cooled air being at a second air temperature T₄, where T₄<T₃; and
a controller, configured to modify a target temperature of water in the water tank from a first, default, target temperature T₁ to a second target temperature, T₂, where T₁<T₂.

41. A system according to claim 40, wherein the controller is further configured to receive a trigger signal, and to modify the target temperature of water in the water tank responsive to the trigger signal; optionally the system further comprising at least one of:
a user input device for generating the trigger signal;
a sensor for generating the trigger signal, in particular a temperature sensor; and
a controller for generating the trigger signal in response to measurements of a sensor, in particular a temperature sensor.

42. A system according to claim 40, wherein the controller is further configured to receive a further trigger signal, and to, in response to the further trigger signal, modifying the target temperature of water in the water tank from the second target temperature, T₂, to the first, default, target temperature T₁; optionally wherein the system is configured to receive the further trigger signal from a, or the, user input device.

43. A system according to claim 42, wherein the system is configured to receive the further trigger signal from a, or the, sensor or from a, or the, controller for generating the trigger signal; and/or the system further comprises a timer, and the further trigger signal is generated by the timer.

44. A system according to claim 43, wherein the further trigger signal is generated by a, or the, sensor, or a controller to which the sensor is communicatively coupled, and wherein the sensor is configured to measure a temperature of at least one of:
the water in the water tank;
exhaust air from the heat pump;
incoming air being received by the heat pump; and
air in a room to which exhaust air from the heat pump is provided.

45. A system according to claim 40, further comprising at least one of:
a second air inlet, in fluid communication with the heat pump; and
a second air outlet, in fluid communication with the heat pump,
wherein the second air inlet and the second air outlet are without a space to be cooled, and the first air inlet and the first air outlet are within the space to be cooled.

46. A system according to claim 45, further comprising a manifold for controlling air flow between the air inlets, the air outlets, and the heat pump, and optionally wherein the manifold is configurable to selectively allow air flow from one of the first air inlet and the second air inlet to the heat pump and/or to selectively allow air flow from the heat pump to one of the first air outlet and the second air outlet.

47. A system according to claim 46, wherein the manifold is configurable between a first configuration, in which the manifold permits air flow between the first air inlet, the heat pump, and the first air outlet, and a second configuration, in which the manifold permits air flow between the second air inlet, the heat pump, and the first air outlet, and optionally wherein the controller is further configured to reconfigure the manifold from the first configuration to the second configuration upon modifying the target temperature of water in the water tank from the first, default, target temperature T₁ to the second target temperature T₂.

48. A system according to claim 40, further comprising a fan for creating flow of the air, and wherein the controller is further configured to modify a flow rate of the air from a first flow rate, FR₁, to a second flow rate, FR₂, wherein FR₂>FR₁, upon modifying the target temperature of water in the water tank from the first, default, temperature T₁ to the second temperature, T₂.

49. A system according to claim 40, configured to be coupled to a mechanical extract ventilation system.

50. An apparatus for providing cooled air, configured to be used in a system of claim 40, the apparatus comprising:
a first air inlet;
a second air inlet;
a first air outlet;
a second air outlet, each of the first air inlet, the second air inlet, the first air outlet, and the second air outlet configured to be in fluid communication with a heat pump; and
a manifold for controlling air flow between the air inlets, the air outlets, and the heat pump,
optionally wherein the manifold is configurable to selectively allow air flow from one of the first air inlet and the second air inlet to the heat pump and/or for selectively allowing air flow from the heat pump to one of the first air outlet and the second air outlet; and further optionally wherein the manifold is configurable between a first configuration, in which the manifold permits air flow between the first air inlet, the heat pump, and the first air outlet, and a second configuration, in which the manifold permits air flow between the second air inlet, the heat pump, and the first air outlet.

51. An apparatus according to claim 50, configured to be retrofittable to a heat pump configured to provide heated water.
